(19) United States
(12) Patent Application Publication
(10) Pub. No.: US 2018/0131167 A1
(43) Pub. Date: May 10, 2018

(54) SINGLE-CORE WIRE AND WIRE HARNESS

(71) Applicant: Sumitomo Wiring Systems, Ltd., Yokkaichi, Mie (JP)

(72) Inventor: Hirokazu NAKAI, Yokkaichi, Mie (JP)

(73) Assignee: Sumitomo Wiring Systems, Ltd., Yokkaichi, Mie (JP)

(21) Appl. No.: 15/564,228

(22) PCT Filed: Mar. 28, 2016
(86) PCT No.: PCT/JP2016/059822

§ 371 Date: Oct. 4, 2017

(30) Foreign Application Priority Data
Apr. 17, 2015 (JP) 2015-084969

(51) Int. Cl. H02G 1/14; H01B 7/00; H01R 11/11

(52) U.S. Cl. CPC H02G 1/14; H01R 11/11; H01B 7/0009

(57) ABSTRACT

A single-core wire that is to be connected to a core wire of a coated electrical wire in which the core wire obtained by combining a plurality of element wires is coated with an insulating coating, including: a main portion in the shape of a solid bar extending in an axial direction; and an electrical wire fixing portion constituting part of the main portion, and having an inner wall arranged around an outer circumference of the core wire before the core wire is fixed and formed so as to be continuous, in which the core wire is fixed in a state of being surrounded by the inner wall.

### CROSS REFERENCE TO RELATED APPLICATIONS

This application claims the priority of Japanese patent application JP2015-084969 filed on Apr. 17, 2015, the entire contents of which are incorporated herein.

### TECHNICAL FIELD

The technique disclosed in this specification relates to a single-core wire and a wire harness.

### BACKGROUND ART

Conventionally, a method described in JP2013-25997A (Patent Document 1) is known as a method for connecting conductors of a round bar wire and a twisted wire. The round bar wire has a conductor in the shape of a flat plate. Meanwhile, the twisted wire has a conductor obtained by twisting together a plurality of element wires. If the conductor of the twisted wire and the conductor of the round bar wire are laid over each other and subjected to ultrasonic joining, a connected portion is formed where these conductors have been joined using ultrasonic joining.

### SUMMARY

However, this sort of joining method using ultrasonic waves is problematic in that, when the twisted wire is pulled upward, the conductor of the twisted wire is likely to be separated from the conductor of the round bar wire. On the other hand, when using a crimping method that crimps the conductor of the twisted wire using a pair of barrels, element wires are likely to stick out, and the element wires that have stuck out may come into contact with another circuit or the like and cause short circuiting between circuits.

An aspect disclosed in this specification is directed to a single-core wire that is to be connected to a core wire of a coated electrical wire in which the core wire obtained by combining a plurality of element wires is coated with an insulating coating, including: a main portion in the shape of a solid bar extending in an axial direction; and an electrical wire fixing portion constituting part of the main portion, and having an inner wall arranged around an outer circumference of the core wire before the core wire is fixed and formed so as to be continuous, in which the core wire is fixed in a state of being surrounded by the inner wall.

With this configuration, the core wire can be surrounded by the inner wall before the core wire is fixed to the electrical wire fixing portion, and thus a situation is prevented in which some of the plurality of element wires are fixed sticking out of the inner wall, and the size of the electrical wire fixing portion can be reduced. Accordingly, a situation is prevented in which element wires that have stuck out come into contact with another circuit or the like and cause short circuiting between circuits.

The single-core wire disclosed in this specification may be configured as follows.

A configuration is possible in which the electrical wire fixing portion before the core wire is fixed is in the shape of a bottomed cavity as a whole.

With this configuration, the core wire can be positioned by inserting the core wire inside the inner wall until the end of the core wire is in contact with the depth end of the inner wall.

A configuration is possible in which the inner wall is an inner wall of an axial-direction cavity that is open in the axial direction at an end portion of the main portion.

With this configuration, the single-core wire and the coated electrical wire are arranged side by side in the axial direction of the main portion.

A configuration is possible in which the inner wall is an inner wall of a radial-direction cavity that is open in a radial direction at an end portion of the main portion.

With this configuration, for example, when the coated electrical wire has to be arranged bent at an angle of 90° relative to the single-core wire, it is not necessary to provide a space for a bend in the coated electrical wire, and thus space can be saved.

Also, an aspect disclosed in this specification is directed to a wire harness including: a single-core wire in the shape of a solid bar; a terminal portion obtained by forming part of the single-core wire into a cavity shape; and a coated electrical wire having a core wire obtained by combining a plurality of element wires, wherein the core wire is conductively connected to an inner wall of the terminal portion.

With this configuration, it is not necessary to newly provide a terminal because part of the single-core wire is used as a terminal portion.

According to the single-core wire disclosed in this specification, element wires can be prevented from sticking out of the electrical wire fixing portion.

### BRIEF DESCRIPTION OF DRAWINGS

FIG. 1 is a perspective view showing a state before a single-core wire is provided with an axial-direction cavity in Embodiment 1.

FIG. 2 is a perspective view showing a state after the single-core wire is provided with the axial-direction cavity.

FIG. 3 is a perspective view showing a state after a core wire of a coated electrical wire is inserted into the axial-direction cavity and subjected to press-fitting.

FIG. 4 is a perspective view showing a state before a single-core wire is provided with a radial-direction cavity in Embodiment 2.

FIG. 5 is a cross-sectional view obtained by cutting the wires in the state shown in FIG. 4 in the vertical direction, as viewed from a side thereof.

FIG. 6 is a perspective view showing a state after the single-core wire is provided with the radial-direction cavity.

FIG. 7 is a cross-sectional view obtained by cutting the wires in the state shown in FIG. 6 in the vertical direction, as viewed from a side thereof.

FIG. 8 is a perspective view showing a state after the core wire of the coated electrical wire is inserted into the radial-direction cavity and subjected to press-fitting.

### DESCRIPTION OF EMBODIMENT

### Embodiment 1

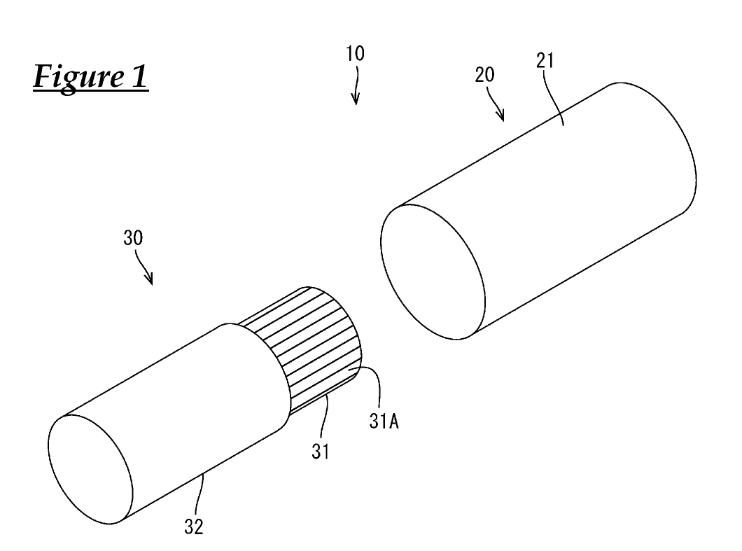

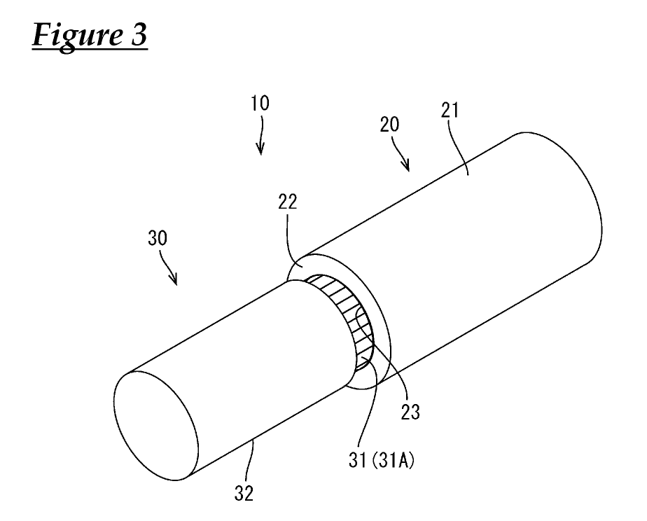

Hereinafter, Embodiment 1 will be described with reference to FIGS. 1 to 3. As shown in FIG. 3, a wire harness 10 in this embodiment includes a single-core wire 20 and a coated electrical wire 30. The wire harness 10 is, for example, an underfloor harness that is arranged under a floor of a vehicle.

The coated electrical wire 30 includes a core wire 31, and an insulating coating 32 made of an insulating resin coating the core wire 31. The core wire 31 is formed by combining a plurality of metal element wires 31A made of a conductive metal. In this embodiment, the core wire 31 is shown as a single wire for the sake of simplicity of the drawings, but the core wire 31 is not limited to a single wire, and may be a core wire configured as a twisted wire.

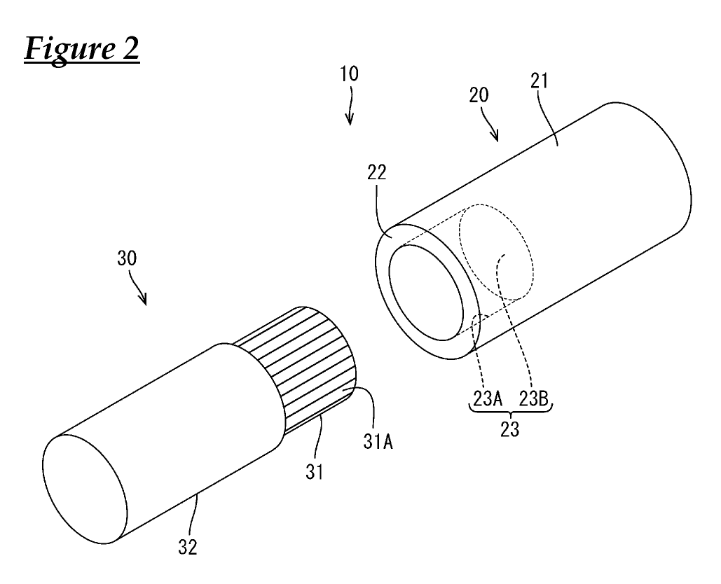

As shown in FIG. 2, the single-core wire 20 includes a main portion 21 in the shape of a solid bar extending in an axial direction, and an electrical wire fixing portion 22 constituting part of the main portion 21. The electrical wire fixing portion 22 before the core wire 31 is fixed thereto is in the shape of a bottomed cavity as a whole, and has an axial-direction cavity 23 that is open in the axial direction of the main portion 21. The inner wall of the axial-direction cavity 23 is constituted by a circumferential wall 23A continuous in a circumferential direction, and a depth wall 23B arranged at the depth end of the circumferential wall 23A. “Solid” refers to an antonym of hollow, and a solid member is a member whose inner portion has not been removed, that is, a member whose inner portion is full.

The core wire 31 is inserted into the axial-direction cavity 23 so as to be surrounded by the circumferential wall 23A. Then, the circumferential wall 23A is crimped around the entire circumference thereof, for example, through hexagonal crimping or the like, so that the circumferential wall 23A is press-fitted to the core wire 31. Accordingly, the core wire 31 of the coated electrical wire 30 is fixed to the electrical wire fixing portion 22, and, at the same time, the circumferential wall 23A of the electrical wire fixing portion 22 and the core wire 31 of the coated electrical wire 30 are conductively connected. That is to say, the electrical wire fixing portion 22 is a terminal obtained by forming part of the single-core wire 20 into a cavity shape, and is also referred to as a terminal portion.

The electrical wire fixing portion 22 in this embodiment is formed by cutting an end portion of the single-core wire 20 from the axial direction into a solid cylinder shape, but may be formed using processing other than cutting, such as pressing. Furthermore, in this embodiment, the core wire 31 is fixed to the electrical wire fixing portion 22 through press-fitting, but the method for fixing the core wire 31 is not limited to press-fitting, and welding methods such as ultrasonic welding or resistance welding also may be used.

As described above, in this embodiment, the core wire 31 can be surrounded by the inner wall (the circumferential wall 23A) before the core wire 31 is fixed to the electrical wire fixing portion 22, and thus a situation is prevented in which some of the plurality of element wires 31A are fixed sticking out of the inner wall, and the size of the electrical wire fixing portion can be reduced. Accordingly, a situation is prevented in which element wires 31A that have stuck out come into contact with another circuit or the like and cause short circuiting between circuits.

The electrical wire fixing portion 22 before the core wire 31 is fixed thereto may be in the shape of a bottomed cavity as a whole.

With this configuration, the core wire 31 can be positioned by inserting the core wire 31 inside the inner wall (the circumferential wall 23A) until the end of the core wire 31 is in contact with the depth end (the depth wall 23B) of the inner wall.

The inner wall may be an inner wall of the axial-direction cavity 23 that is open in the axial direction at an end portion of the main portion 21.

With this configuration, the single-core wire 20 and the coated electrical wire 30 are arranged side by side in the axial direction of the main portion 21.

Furthermore, the wire harness 10 disclosed in this specification may include the single-core wire 20 in the shape of a solid bar, the terminal portion (the electrical wire fixing portion 22) obtained by forming part of the single-core wire 20 into a cavity shape, and the coated electrical wire 30 having the core wire 31 obtained by combining the plurality of element wires 31A, wherein the core wire 31 is conductively connected to an inner wall of the terminal portion.

With this configuration, it is not necessary to newly provide a terminal because part of the single-core wire 20 is used as a terminal portion (the electrical wire fixing portion 22).

### Embodiment 2

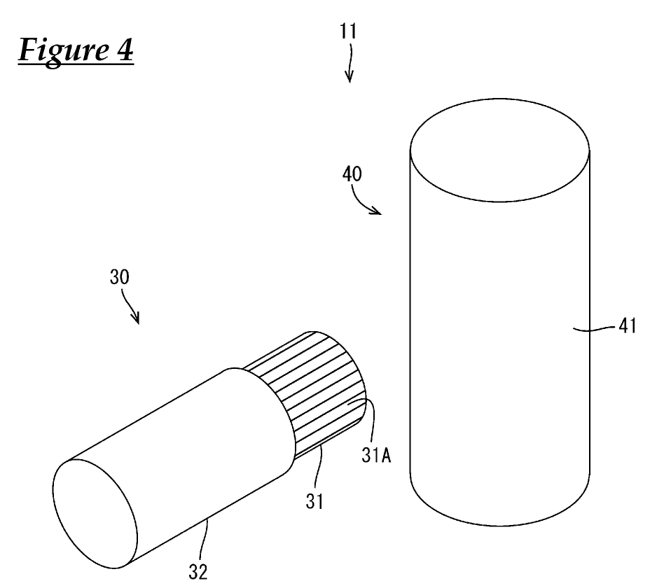

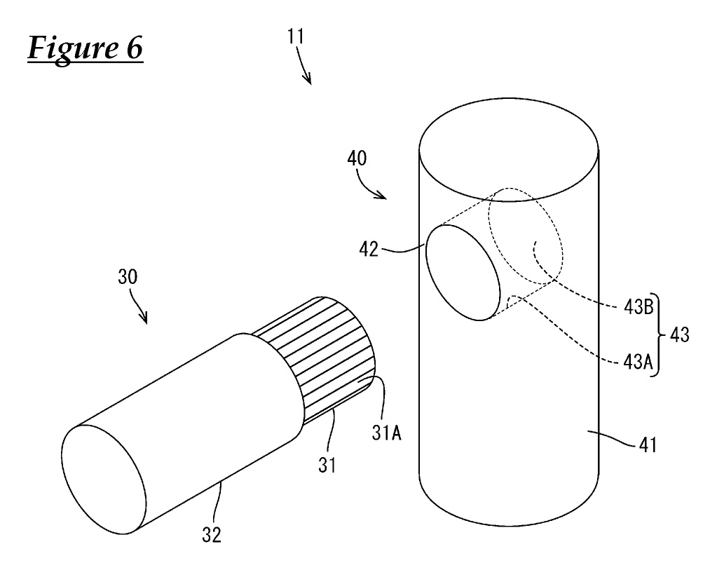

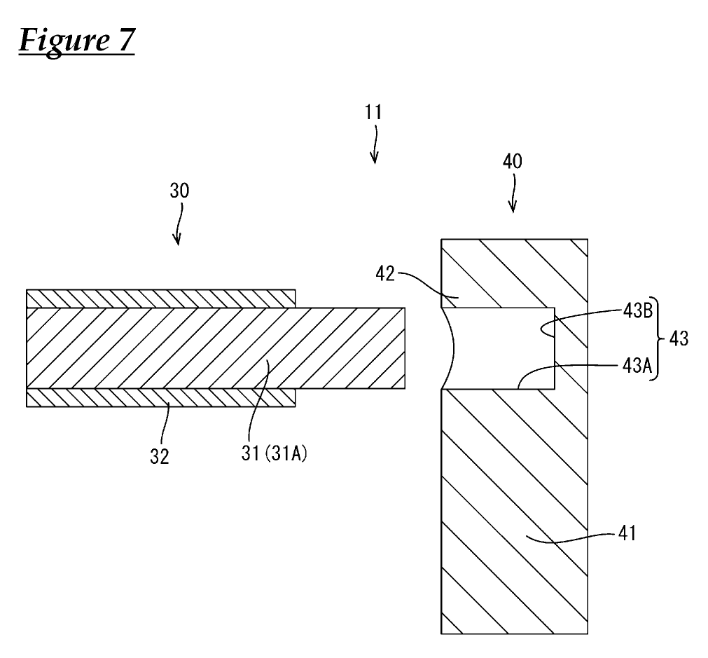

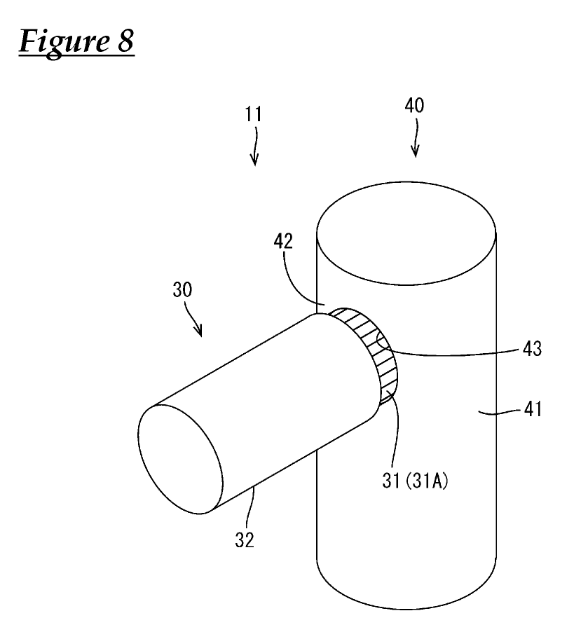

Next, Embodiment 2 will be described with reference to FIGS. 4 to 8. A wire harness 11 in this embodiment includes a single-core wire 40 shown in FIG. 6, and the coated electrical wire 30 as in Embodiment 1. The single-core wire 40 in this embodiment is different from the single-core wire 20 in Embodiment 1 in terms of the direction of the cavity, and has a radial-direction cavity 43 that is open in a radial direction at an end portion of a main portion 41 as shown in FIGS. 6 and 7. The inner wall of the radial-direction cavity 43 is constituted by a circumferential wall 43A continuous in a circumferential direction, and a depth wall 43B arranged at the depth end of the circumferential wall 43A.

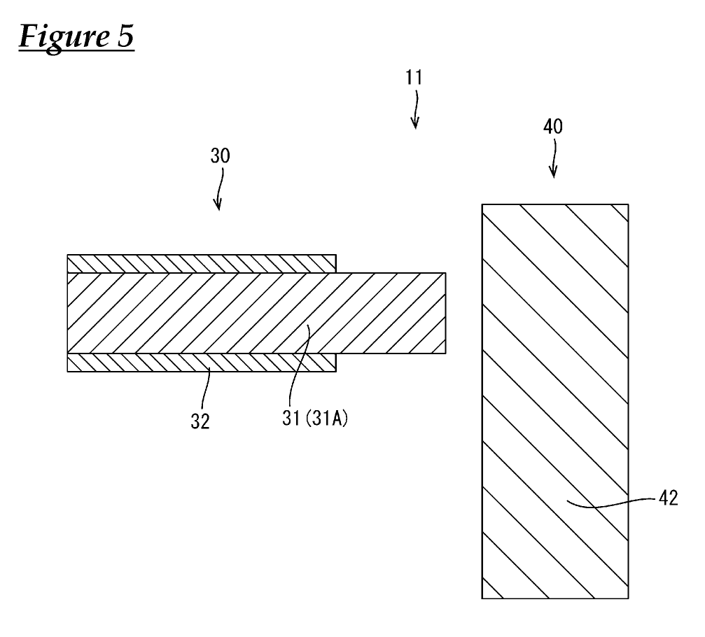

With this configuration, for example, when the coated electrical wire 30 has to be arranged bent at an angle of 90° relative to the single-core wire 40 as shown in FIGS. 4 and 5, the wires can be fixed merely by inserting the core wire 31 from a side of the main portion 41 into the radial-direction cavity 43 and press-fitting the wires through crimping. Accordingly, an L-shaped arrangement can be realized by the single-core wire 40 in the shape of a straight line and the coated electrical wire 30 in the shape of a straight line without bending the coated electrical wire 30. Thus, it is not necessary to provide a space for a bend in the coated electrical wire 30, and thus space can be saved.

### Other Embodiments

The techniques disclosed in the specification are not limited to the embodiments described by way of the above descriptions and figures, and various modes such as the following, for example, are also encompassed.

Although the single-core wire is in the shape of a round bar in the foregoing embodiments, the single-core wire may be in the shape of a square bar.

Although the electrical wire fixing portion in the shape of a bottomed cavity is shown as an example in Embodiment 2, but the electrical wire fixing portion may be a through hole.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### LIST OF REFERENCE NUMERALS

10, 11 . . . Wire harness

20, 40 . . . Single-core wire

21, 41 . . . Main portion

22, 42 . . . Electrical wire fixing portion (terminal portion)

23 . . . Axial-direction cavity

23A . . . Circumferential wall (inner wall)

23B . . . Depth wall (inner wall)

30 . . . Coated electrical wire

31 . . . Core wire

31A . . . Element wire

32 . . . Insulating coating

43 . . . Radial-direction cavity

43A . . . Circumferential wall

43B . . . Depth wall

1. A single-core wire that is to be connected to a core wire of a coated electrical wire in which the core wire obtained by combining a plurality of element wires is coated with an insulating coating, comprising:
a main portion in the shape of a solid bar extending in an axial direction; and
an electrical wire fixing portion constituting part of the main portion, wherein the electrical wire fixing portion before the core wire is fixed is in the shape of a bottomed cavity as a whole, and has an axial-direction cavity that is open in the axial direction at an end portion of the main portion, and an inner wall of the axial-direction cavity is constituted by a circumferential wall continuous in a circumferential direction, and a depth wall arranged at a depth end of the circumferential wall, and
the core wire is fixed to the electrical wire fixing portion in a state where the core wire is surrounded by the circumferential wall and an end of the core wire is contact with the depth wall.

2. (canceled)

3. (canceled)

4. A single-core wire that is to be connected to a core wire of a coated electrical wire in which the core wire obtained by combining a plurality of element wires is coated with an insulating coating, comprising:
a main portion in the shape of a solid bar extending in an axial direction; and
an electrical wire fixing portion constituting part of the main portion,
wherein the electrical wire fixing portion before the core wire is fixed is in the shape of a bottomed cavity as a whole, and has a radial-direction cavity that is open in a radial direction at an end portion of the main portion, and an inner wall of the radial-direction cavity is constituted by a circumferential wall continuous in a circumferential direction, and a depth wall arranged at a depth end of the circumferential wall, and
the core wire is fixed to the electrical wire fixing portion in a state where the core wire is surrounded by the circumferential wall and an end of the core wire is contact with the depth wall.

5. A wire harness comprising:
the single-core wire in the shape of a solid bar according to claim 1; and
a coated electrical wire having a core wire obtained by combining a plurality of element wires, wherein the core wire is conductively connected to the circumferential wall.
